(19) United States
(12) Patent Application Publication
(10) Pub. No.: US 2015/0332198 A1
(43) Pub. Date: Nov. 19, 2015

(54) APPARATUS, SYSTEM, AND METHOD FOR ELECTRONIC DISPLAY OF METRICS

(71) Applicant: KPI FIRE, INC., Provo, UT (US)

(72) Inventor: Cedro Toro, Lehi, UT (US)

(21) Appl. No.: 14/692,569

(22) Filed: Apr. 21, 2015

Related U.S. Application Data
(60) Provisional application No. 61/982,313, filed on Apr. 21, 2014.

(51) Int. Cl. G06Q 10/06

(52) U.S. Cl. CPC G06Q 10/06393

(57) ABSTRACT

Apparatuses, systems, methods, and computer program products are disclosed for electronic display of metrics. An objective module displays an objective in association with one or more supporting factors for the objective. At least one supporting factor for an objective comprises one or more of another objective, a metric, and a project. A metric module displays a metric in association with one or more supporting factors for the metric. At least one supporting factors for a metric comprises one or more of an objective, another metric, and a project. A project module displays information associated with a project in association with one or more of an objective and a metric supported by the project.

### CROSS-REFERENCES TO RELATED APPLICATIONS

This application claims the benefit of U.S. Provisional Patent Application No. 61/982,313 entitled “TRACKING BUSINESS STRATEGY AND PERFORMANCE” and filed on Apr. 21, 2014 for Cedro Toro, which is incorporated herein by reference.

### TECHNICAL FIELD

The present disclosure, in various embodiments, relates to an electronic display and more particularly relates to an electronic display of one or more tracked metrics.

### BACKGROUND

A strategic plan for a business or another organization may involve several strategic goals, objectives, or initiatives. Metrics allow a business to measure its performance, or its progress towards its objectives. Projects may be designed to affect various metrics, or to achieve or support specific objectives. Various separate solutions may have been tried for managing and tracking business objectives, for tracking metrics, and for managing projects. For example, a company may use a strategic planning system to develop and track its objectives or goals, may use a dashboard-type system to track metrics, and may use a project management system to manage projects. However, it can be difficult or impossible, using currently available solutions, to understand the complex interconnections between objectives, metrics, and projects.

### SUMMARY

Methods are presented for electronic display of metrics. In one embodiment, a method includes displaying an objective in association with one or more supporting factors for the objective. At least one supporting factor for an objective, in certain embodiments, comprises another objective, a metric, and/or a project. A method, in a further embodiment, includes displaying a metric in association with one or more supporting factors for the metric. At least one supporting factors for a metric, in certain embodiments, comprises an objective, another metric, and/or a project. In another embodiment, a method includes displaying information associated with a project in association with an objective and/or a metric supported by the project. In various embodiments, a displayed objective, a displayed metric, and/or displayed information is displayed as an element of a smart breadcrumb comprising an ordered list of multiple elements. A method, in one embodiment, includes storing a record of an association between an action, a reward for the action, and one or more of an objective, a metric, a project, a group of objectives, a group of metrics, and a group of projects supported by the action.

Apparatuses are presented for electronic display of metrics. In one embodiment, an objective module displays an objective in association with one or more supporting factors for the objective. At least one supporting factor for an objective, in certain embodiments, comprises another objective, a metric, and/or a project. A metric module, in a further embodiment, displays a metric in association with one or more supporting factors for the metric. At least one supporting factor for a metric comprises an objective, another metric, and/or a project. In another embodiment, a project module displays information associated with a project in association with an objective and/or a metric supported by the project.

Other apparatuses are presented for electronic display of metrics. In one embodiment, a tile module displays a plurality of tiles. A tile, in certain embodiments, comprises a chart. A data connection module, in a further embodiment, connects a chart to data for the chart in response to a user activating a data connection control for a tile. A color scheme module, in another embodiment, displays a color scheme for a tile according to a category for the tile.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for tracking business strategy and performance;

FIG. 2 is a schematic block diagram illustrating one embodiment of a business tracking apparatus;

FIG. 3 is a schematic block diagram illustrating another embodiment of a business tracking apparatus;

FIG. 4 is a schematic flow chart diagram illustrating one embodiment of a method for tracking business strategy and performance;

FIG. 5 is a schematic flow chart diagram illustrating another embodiment of a method for tracking business strategy and performance;

FIG. 6 is a schematic flow chart diagram illustrating another embodiment of a method for tracking business strategy and performance;

FIG. 7 is a schematic flow chart diagram illustrating one embodiment of a method of data display;

FIG. 8 is a schematic block diagram illustrating one embodiment of a web-based application for tracking business strategy and performance;

FIG. 9 is a schematic block diagram further illustrating the web-based application of FIG. 8;

FIG. 10 is a schematic block diagram further illustrating the web-based application of FIG. 8;

FIG. 11 is a schematic block diagram further illustrating the web-based application of FIG. 8;

FIG. 12 is a schematic block diagram further illustrating the web-based application of FIG. 8;

FIG. 13 is a schematic block diagram further illustrating the web-based application of FIG. 8;

FIG. 14 is a schematic block diagram further illustrating the web-based application of FIG. 8;

FIG. 15 is a schematic block diagram further illustrating the web-based application of FIG. 8;

FIG. 16 is a schematic block diagram further illustrating the web-based application of FIG. 8;

FIG. 17 is a schematic block diagram further illustrating the web-based application of FIG. 8; and

FIG. 18 is a schematic block diagram further illustrating the web-based application of FIG. 8.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing.

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. In one embodiment, the program code may be written in a combination of languages including Angular JS, Node JS, JavaScript, D3 and HTML5. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

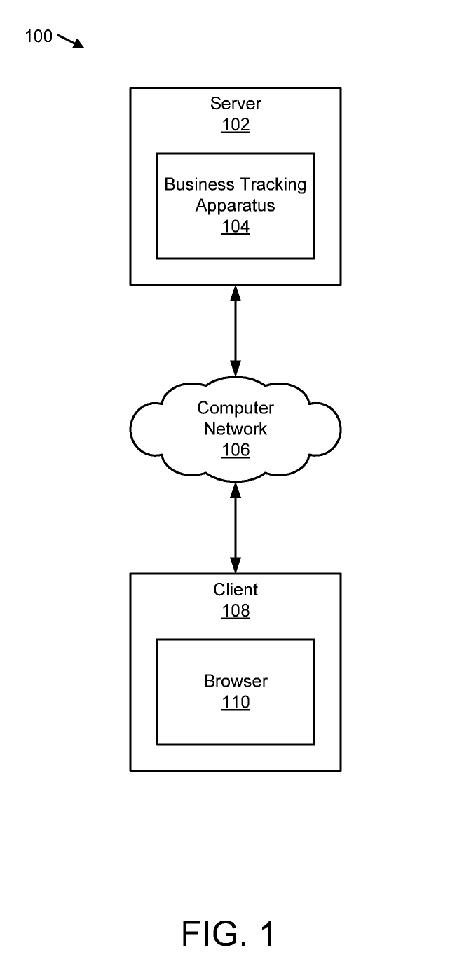

FIG. 1 depicts one embodiment of a system 100 for tracking business strategy and performance. In the depicted embodiment a system 100 for tracking business strategy and performance includes a business tracking apparatus 104 operating on a server 102, as well as a computer network 106, and a browser 110 operating on a client 108, as described below.

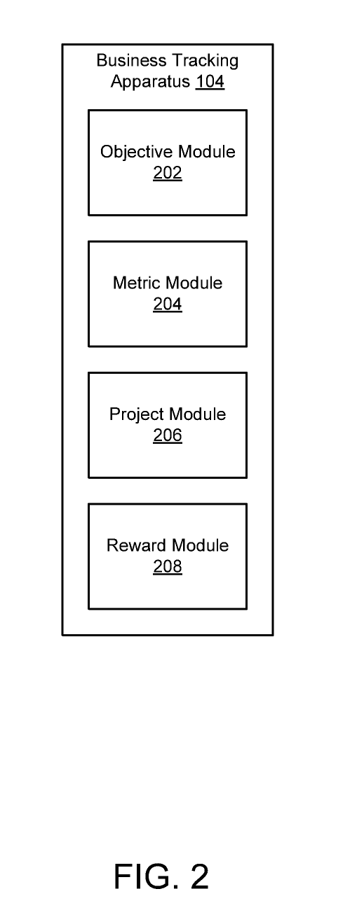

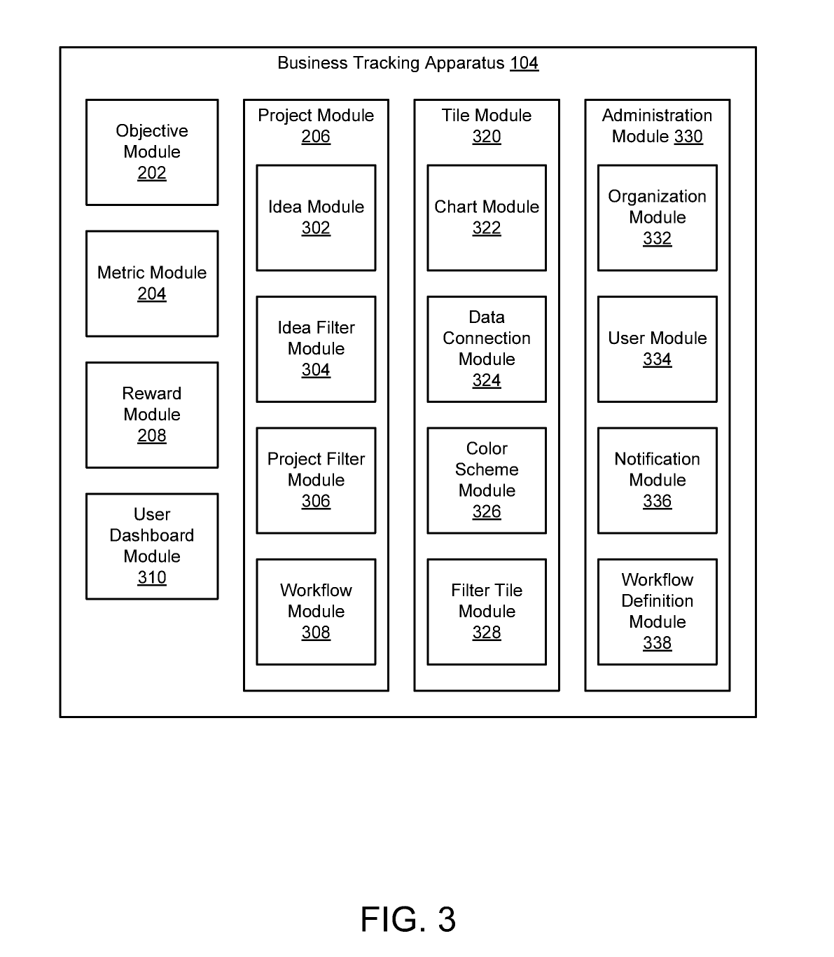

In general, the business tracking apparatus 104 tracks objectives, metrics, and projects for a business or other organization, and displays objectives, metrics, and projects with their connections to other objectives metrics, and projects. The business tracking apparatus 104 is described in more detail below with regard to FIGS. 2 and 3.

In the depicted embodiment, the business tracking apparatus 104 operates on a server 102. In another embodiment, the business tracking apparatus 104 may operate on a plurality of servers 102. In various embodiments, a server 104 may include a mainframe computer, a blade server, a workstation, a desktop or other computer, or the like. Many different types of servers 102 will be clear, in light of this disclosure that may be suitable for operating a business tracking apparatus 104.

In the depicted embodiment, the server 102 and the client 110 communicate via a computer network 106. In one embodiment, the computer network 106 may be a single network. In another embodiment, the computer network 106 may include several networks linked together. In various embodiments, the computer network 106 may include various network types, such as a local area network (“LAN”), wide area network (“WAN”), wireless network, or the like, as well as combinations of network types. In a certain embodiment, the computer network 106 may be a public network such as the internet. In another embodiment, the computer network 106 may be a virtual private network operating over a public network. In yet another embodiment, the computer network 106 may be a private network, such as a corporate intranet.

In one embodiment, the computer network 106 may include hardware such as the server 102, routers, switches, cabling, and other communication hardware. In light of this disclosure, many types of computer network 106, and components of a computer network 106, are clear.

In the depicted embodiment, the system 100 includes a client 108. In one embodiment, a user accesses the business tracking apparatus 104 by using the client 108 to communicate with the server 102 over the computer network 106. In various embodiments, the client 108 may be a desktop computer, a laptop computer, a tablet, a mobile phone, or the like. Although only one client 108 is shown in FIG. 1, the system 100, in a further embodiment, may include multiple clients 108. For example, in one embodiment, multiple people within a business or other organization may use multiple clients 108 connected to the computer network 106 in order to access the business tracking apparatus 104. In a further embodiment, a single user may use multiple clients 108. For example, a user may access the business tracking apparatus 104 using a desktop computer as a client 108 at work, and using a mobile phone as a client 108 away from work. In light of this disclosure, it is clear that many types of devices are suitable for use as a client 108.

In the depicted embodiment, a browser 110 operates on the client 108, and the business tracking apparatus 104 interacts with a user via the browser 110, using the browser 110 to receive information and to display information. In one embodiment, the browser 110 may be a general-purpose application for displaying web pages, and the business tracking apparatus 104 may present information to the user in a web page a series of web pages displayed by the browser 110. In another embodiment, however, the browser 110 may be a specific-purpose application (e.g., an “app”) for use with the business tracking apparatus 104, and the business tracking apparatus 104 may present information to the user in another form, instead of as a web page.

Although the above-disclosed browsers 110 display information in visual form, other types of browsers 110 may be used in other embodiments, to present information in non-visual form. For example, a browser 110 for a blind person may include a screen reader, which audibly reads information from the social networking service 110 instead of, or in addition to displaying it on a screen. For simplicity, the word “display” is used herein to refer to the presentation of information in visual and/or non-visual form, and is not intended to limit this disclosure to visible displays.

Similarly, the above description of a server-client architecture for the system 100 is intended as illustrative, and not limiting; in another embodiment, a system 100 for tracking business strategy and performance may have a different architecture. For example, in one embodiment, the business tracking apparatus 104 may be a local application for one user, and the system 100 may include one computer, without a computer network 106. In another embodiment, a system 100 including the business tracking apparatus 104 may include a peer-to-peer architecture. Many types of system architectures that allow a business tracking apparatus 104 to operate and to interact with a user, or users, are clear in light of this disclosure.

FIG. 2 depicts one embodiment of a business tracking apparatus 104. The business tracking apparatus 104 may be substantially similar to the business tracking apparatus 104 described above with regard to FIG. 1. In general, as described above, the business tracking apparatus 104 tracks objectives, metrics, and projects for a business or other organization, and displays objectives, metrics, and projects with their connections to other objectives metrics, and projects.

In the depicted embodiment, the business tracking apparatus includes an objective module 202, a metric module 204, a project module 206, and a reward module 208. In certain embodiments, the reward module 208 may be optionally included or excluded. For example, in another embodiment, the business tracking apparatus 104 may include the objective module 202, the metric module 204, and the project module 206, but may omit the reward module 208.

The objective module 202, in one embodiment, is configured to display an objective and/or a tree of objectives. In various embodiments, an objective may be a statement of an achievable goal, purpose, or desired outcome for a business or other organization. Accordingly, terms such as “objective,” “initiative,” “strategic goal,” “key business objective,” or the like may be used interchangeably herein to refer to an objective.

In one embodiment, the objective module 202 may create records of objectives. In a further embodiment, the objective module 202 may receive and/or track information about the objectives, such as a description of an objective, a start date, an end date, supporting factors as described below, organizations or people responsible for the objective, or the like. In a certain embodiment, the objective module 202 may receive some information about the objective from a user. For example, in one embodiment, the objective module 202 may prompt the user to enter a description of the objective, an end date, and further information.

In a further embodiment, the objective module 202 may receive additional information about an objective from a source other than a user (e.g., a separate database, a separate computer application, etc.), or indirectly from a user. For example, in one embodiment, the objective module 202 may timestamp an objective with a start date based on when the objective was created. In another embodiment, the objective module 202 may automatically assign an objective to an organization based on the organization responsible for a parent objective. In certain embodiments, the objective module 202 may allow users to edit information about objectives. For example, in one embodiment, the objective module 202 may allow a user to mark an objective as met, or to remove an objective. In light of this disclosure, various methods for tracking and managing business objectives are clear. For example, techniques in use by existing strategic planning software may also be used by the objective module 202, in certain embodiments.

In one embodiment, the objective module 202 may associate an objective with one or more supporting factors. In certain embodiments, a supporting factor for an objective may be another objective, a metric, or a project, which supports, affects, or influences the objective, or which indicates the progress of the objective. For example, in one embodiment, an objective to decrease costs may be supported by a more specific objective to decrease labor costs. Similarly, in another embodiment, an objective to decrease costs in 2014 may be supported by various metrics that measure particular costs, changes in costs from 2013, or the like. Again, in a further embodiment, an objective to decrease costs may be supported by a project that includes specific tasks for decreasing costs in a particular department. Thus, in some embodiments, any objective may be supported by a tree of objectives, metrics, and/or projects.

In one embodiment, the objective module 202, metric module 204, and project module 206 may create data objects representing objectives, metrics, and projects, respectively. In a further embodiment, the objective module 202 may associate an objective with supporting factors by linking a data object for an objective to a data object for a supporting objective, metric or project, recording an association between the objective and a supporting factor in a table of associations, or the like. In one embodiment, the objective module 202 may associate an objective with a supporting factor in response to user input. For example, in a certain embodiment, the objective module 202 may prompt a user to enter or create a supporting factor for an objective when the objective is created.

In one embodiment, the objective module 202 may link an objective to a supporting factor that already exists, such as a previously created objective, metric, or project. For example, in a further embodiment, the objective module 202 may prompt a user to select an existing objective, metric, or project from a list, as a supporting factor. In another embodiment, the objective module 202 may begin creating an association between an objective and a supporting factor, and then prompt a user to create the supporting factor. In view of this disclosure, several ways of associating or linking objectives with supporting objectives, metrics, and projects are clear. In further embodiments, the objective module 202 may similarly unlink objectives from supporting factors.

In one embodiment, the objective module 202 may display one or more objectives in association with one or more supporting factors for the objectives. For example, in a certain embodiment, the objective module 202 may display a tree that lists multiple objectives with their supporting factors in parent/child relationships, lists further supporting factors for the supporting factors, and so on. In one embodiment, a placeholder objective, or a very general objective such as “improve the business” may be placed at the root of the tree with the most important objectives as its supporting factors, so that all the objectives, including objectives which may be otherwise unrelated, appear as branches of one tree.

In a further embodiment the objective module 202 may omit repeated supporting factors that appear in the same branch of the tree, to avoid attempting to display an infinite tree. In another embodiment, the objective module 202 may display a portion of a tree which a user may expand or contract. For example, in one embodiment, the objective module 202 may display an objective with a list of its supporting factors, and allow a user to select one or more of the supporting factors to see second-level supporting factors, or to close a list of supporting factors to see the tree at a higher level of abstraction.

In another embodiment, the objective module 202 may display one or more objectives in association with one or more supporting factors without displaying a tree. For example, in one embodiment, the objective module 202 may not use a root node for a tree, so the most important objectives may be unrelated. However, in a further embodiment, the objective module 202 may display the most important objectives in a list, and may display a list of supporting factors for a selected objective on the list. In another embodiment, the objective module 202 may display a detailed view for a single objective that includes at least one supporting factor for the objective, along with other information about the objective such as its start date, end date, responsible organizations, and the like. Many different ways of displaying objectives with supporting factors will be clear in light of this disclosure.

The metric module 204, in one embodiment, is configured to display a metric and/or a tree of metrics. In various embodiments, a metric may be a measured indicator of a business or other organization's performance, whether in aggregate or in relation to a specific activity. Accordingly, terms such as “metric,” “measurement,” “performance indicator,” “key performance indicator,” or the like may be used interchangeably herein to refer to a metric.

In one embodiment, the metric module 204 may create records of metrics. In a further embodiment, the metric module 204 may receive and/or track information about the metrics, such as a description of a metric, values for the metric over time, supporting factors as described below, organizations or people associated with the metric, or the like. In a certain embodiment, the metric module 204 may receive some information about the metric from a user. For example, in one embodiment, the metric module 204 may prompt the user to enter a description of the metric, and to enter data for the metric, or link the metric to a data source.

In a further embodiment, the metric module 204 may receive additional information about a metric from a source other than a user, or indirectly from a user. For example, in one embodiment, the metric module 204 may automatically update values for a metric when a database linked to the metric is updated. In another embodiment, the metric module 204 may automatically assign a metric to an organization based on the organization responsible for a parent metric. In certain embodiments, the metric module 204 may allow users to edit information about metrics. For example, in one embodiment, the metric module 202 may allow a user to manually update values for a metric, or to remove a metric. In light of this disclosure, various methods for tracking and managing metrics are clear. For example, techniques in use by existing measurement dashboard or performance management software may also be used by the metric module 204, in certain embodiments.

In one embodiment, the metric module 204 may associate a metric with one or more supporting factors. In certain embodiments, a supporting factor for a metric may be an objective, another metric, or a project, which affects, impacts, or influences the metric. In various embodiments, a metric may be a supporting factor for an objective as described above with regard to the objective module 202, but an objective may also be a supporting factor for a metric. For example, in one embodiment, several cost-related metrics may be supporting factors for an objective of decreasing costs, indicating that those metrics may indicate the progress that objective. However, in another embodiment, several specific cost-reducing objectives may be supporting factors for a cost-related metric, indicating that fulfilling any of those objectives will affect the value of that measurement or metric.

In some embodiments, metrics may be supporting factors for other metrics. For example, in one embodiment, a cost metric may be supported by a labor cost metric, utility cost metric, supplies cost metric, and the like. In a further embodiment, some metrics may be mathematically related to other metrics among their supporting factors. For example, in one embodiment, a total cost metric may be the sum of several more specific cost metrics. In another embodiment, a metric may be non-mathematically related to metrics among its supporting factors, but may be measured separately. For example, in one embodiment, a customer satisfaction metric may have a customer waiting time metric among its supporting factors, but customer satisfaction may be measured according to customer satisfaction surveys, independent of measurements of customer waiting time.

Similarly, in certain embodiments, a project may be a supporting factor for a metric, indicating that working on or completing the project will likely affect the metric. For example, in one embodiment, a cost metric may be supported by a project that includes specific tasks for decreasing costs in a particular department. Thus, in some embodiments, any metric may be supported by a tree of objectives, metrics, and/or projects.

In one embodiment, the objective module 202, metric module 204, and project module 206 may create data objects representing objectives, metrics, and projects, respectively. In a further embodiment, the metric module 204 may associate a metric with supporting factors by linking a data object for a metric to a data object for a supporting objective, metric or project, recording an association between the metric and a supporting factor in a table of associations, or the like. In one embodiment, the metric module 204 may associate a metric with a supporting factor in response to user input. For example, in a certain embodiment, the metric module 204 may prompt a user to enter or create a supporting factor for a metric when the metric is created.

In one embodiment, the metric module 204 may link a metric to a supporting factor that already exists, such as a previously created objective, metric, or project. For example, in a further embodiment, the metric module 204 may prompt a user to select an existing objective, metric, or project from a list, as a supporting factor. In another embodiment, the metric module 204 may begin creating an association between a metric and a supporting factor, and then prompt a user to create the supporting factor. In view of this disclosure, several ways of associating or linking metrics with supporting objectives, metrics, and projects are clear. In further embodiments, the metric module 204 may similarly unlink metrics from supporting factors.

In one embodiment, the metric module 204 may display one or more metrics in association with one or more supporting factors for the metrics. For example, in a certain embodiment, the metric module 204 may display a tree that lists multiple metrics with their supporting factors in parent/child relationships, lists further supporting factors for the supporting factors, and so on. In one embodiment, a placeholder metric may be placed at the root of the tree with the most important metrics as its supporting factors, so that all the metrics, including metrics which may be otherwise unrelated, appear as branches of one tree.

In a further embodiment the metric module 204 may omit repeated supporting factors that appear in the same branch of the tree, to avoid attempting to display an infinite tree. In another embodiment, the metric module 204 may display a portion of a tree which a user may expand or contract. For example, in one embodiment, the metric module 204 may display a metric with a list of its supporting factors, and allow a user to select one or more of the supporting factors to see second-level supporting factors, or to close a list of supporting factors to see the tree at a higher level of abstraction.

In another embodiment, the metric module 204 may display one or more metrics in association with one or more supporting factors without displaying a tree. For example, in one embodiment, the metric module 204 may not use a root node for a tree, so the most important metrics may be unrelated. However, in a further embodiment, the metric module 204 may display the most important metrics in a list, and may display a list of supporting factors for a selected metric on the list. In another embodiment, the metric module 204 may display a detailed view for a single metric that includes at least one supporting factor for the metric, along with other information about the metric such as its data source, a preferred type of chart for visualizing the metric, responsible organizations, and the like. Many different ways of displaying metrics with supporting factors will be clear in light of this disclosure.

The project module 206, in one embodiment, is configured to display information about a project, or multiple projects. In various embodiments, a project may be a specific process, operation or set of operations designed to accomplish a particular goal, objective, or outcome. In some embodiments, the objective module 202 may display an objective by displaying a statement of the objective or information about an objective, and the metric module 204 may display a metric by displaying at least one value for the metric, or other information about the metric. Similarly, in certain embodiments, the project module 206 may display a project by displaying information about a project. Accordingly, the terms “objective,” “metric,” and “project” may be used herein to refer to the real-world objectives, metrics and projects, to information about the objectives, metrics and projects stored by the business tracking apparatus 104, or to data objects or structures used by the business tracking apparatus to represent objectives, metrics, and projects.

In one embodiment, the project module 206 may create records of projects. In a further embodiment, the project module 206 may receive and/or track information about the projects, such as a description of a project, a start date, a projected end date, supporting factors as described below, organizations or people responsible for the project, a workflow, or list of tasks associated with the project or the like. In a certain embodiment, the project module 206 may receive some information about the project from a user. For example, in one embodiment, the project module 206 may prompt the user to enter a description of the project, a projected end date, and further information.

In a further embodiment, the project module 206 may receive additional information about a project from a source other than a user, or indirectly from a user. For example, in one embodiment, the project module 206 may timestamp a project with a start date based on when the project was created. In another embodiment, the project module 206 may automatically assign a project to an organization based on the organization responsible for a supported objective. In certain embodiments, the project module 206 may allow users to edit information about projects. For example, in one embodiment, the project module 206 may allow a user to mark tasks for the project as completed, or to remove a project. In light of this disclosure, various methods for tracking and managing projects are clear. For example, techniques in use by existing project management software may also be used by the project module 206, in certain embodiments.

In some embodiments, the project module 206 may associate projects with supporting factors including objectives, metrics, or other projects, substantially as described above with regard to the objective module 202 and the metric module 202 associating supporting factors with objectives or metrics. Similarly, the project module 202 may display trees or lists of projects with supporting factors, as described above.

In certain embodiments, the project module 206 may associate a project with an objective or a metric, as a supporting factor for the objective or the metric. For example, in one embodiment, the project module 206 may prompt a user creating a project to indicate which objectives or metrics the project supports. In a further embodiment, the project module 206 may provide an interface for adding supported objectives and metrics to existing projects. In one embodiment, the project module 206 may invoke the objective module 202 or the metric module 204 to link an objective or a metric, respectively, to a project as a supporting factor. In another embodiment, the project module 206 may include similar logic to link an objective or a metric to a supporting project without invoking the objective module 202 or the metric module 204. In further embodiments, the project module 206 may similarly unlink projects from supporting factors, or from supported metrics and objectives.

In one embodiment, the project module 206 may display information about a project in association with objectives and/or metrics supported by the project. For example, in a certain embodiment, the project module 206 may display a list of projects with a top-level metric supported by each project. In another embodiment, the project module 206 may display a detailed view for a single project that includes at least one objective or metric supported by the project, a list of objectives or metrics supported by the project, a tree of objectives or metrics supported by the first objectives and metrics, or the like. In a further embodiment, the detailed view for the project may include additional information about the project such as a workflow, or list of tasks for the project, start and end dates, responsible organizations, and the like. In certain embodiments, the project module 206 may display an indication of whether a displayed project is a corrective action. The project module is described below in further detail with regard to the idea module 302, the idea filter module 304, the project filter module 306, and the workflow module 308 of FIG. 3.

The reward module 208, in one embodiment, is configured to incentivize various actions and track rewards and recognition for the various actions. In general, in various embodiments, a reward may refer to any form of award, recognition, or article given in recognition. For example, in one embodiment, a reward may refer to a tangible reward such as money or goods given as a reward for specific achievements. In another embodiment, a reward may refer to a virtual reward tracked by the reward module 208, such as a description of an achievement added to a list of achievements, an achievement level, a certain number of experience points, or the like. (The term “tangible award” is used herein to distinguish certain awards from “virtual awards” that exist within the business tracking apparatus 104, but is not intended to indicate whether an award is literally tangible. Thus a sum of money may be described as a tangible award regardless of whether an actual check or cash is presented or whether the money is electronically deposited into a bank account.)

In one embodiment, the reward module 208 may incentivize an action by keeping a record of an association between an action and a reward for the action. In a further embodiment, the reward module 208 may interact with the objective module 202, the metric module 204 and the project module 206 to further associate the incentivized action with a particular objective, metric or project, or with a group of objectives, metrics, or projects. For example, in one embodiment, a reward may be a supporting factor for an objective, a metric or a project and/or may be displayed as a supporting factor by the objective module 202, the metric module 204, and/or the project module 206.

In one embodiment, the reward module 208 may associate the incentivized action and its reward with a particular objective, metric, or project. For example, in a further embodiment, the reward module 208 may associate a particularly significant reward with completing a high-value project. In another embodiment, the reward module 208 may associate an incentivized action and its reward with a group of objectives, metrics, or projects. For example, in a further embodiment, the reward module 208 may associate a standard reward and the action of completing a project with a group of typical-value projects. As further examples, in various embodiments, the reward module 208 may associate a reward for the action of submitting an idea (that may lead to a project) with the group of projects in general, or may associate a reward for reducing any type of costs by a specific percentage with a total cost metric, a group of cost metrics, an objective or group of objectives for reducing costs, or the like. In light of this disclosure, many ways are clear in which objectives, metrics and projects may be associated with rewards, either alone or in groups.

In one embodiment, the reward module 208 may be configured to reward people according to the associated rewards for performing the incentivized actions. In one embodiment, a reward may be a tangible reward, such as a tangible good or a sum of money, and the reward module 208 may notify a user that the reward may be claimed, or may notify a manager that the reward should be given. In a further embodiment, the reward module 208 may record that the reward was earned. In another embodiment, a reward may be a virtual award such as an achievement level, a certain number of experience points, or the like, and the reward module 208 may reward a person itself by issuing the virtual reward. In a further embodiment, the reward module 208 may track a cumulative award total for a person, and may add a virtual reward to the cumulative total. For example, in various embodiments, the reward module 208 may add a certain number of experience points to an experience point total, add a virtual achievement to a list of achievements, increment a cumulative achievement level, or the like.

In one embodiment, the reward module 208 may associate a reward with an action for individual people to complete, and may reward individual people for completing the action. For example, in a further embodiment, the reward module 208 may reward individuals for submitting ideas that may lead to projects. In another embodiment, the reward module 208 may associate a reward with an action for a group to complete, and may reward the group for completing the action. For example, in a further embodiment, the reward module 208 may reward a group, or each member of a group, for completing a project that the group is responsible for. In light of this disclosure, various methods for tracking and managing recognition and rewards are clear. For example, techniques in use by existing reward and recognition software may also be used by the reward module 208, in certain embodiments.

FIG. 3 depicts another embodiment of a business tracking apparatus 104. The business tracking apparatus 104, in certain embodiments, may be substantially similar to the business tracking apparatus 104 described above with regard to FIGS. 1 and 2. In the depicted embodiment, the business tracking apparatus 104 includes an objective module 202, a metric module 204, a project module 206, and a reward module 208, which may be configured substantially as described above with regard to FIG. 2. The business tracking apparatus 104, in the depicted embodiment, includes a user dashboard module 310, a tile module 320, and an administration module 330. The project module 206, in the depicted embodiment, includes an idea module 302, an idea filter module 304, a project filter module 306, and a workflow module 308. The tile module 320, in the depicted embodiment, includes a chart module 322, a data connection module 324, a color scheme module 326, and a filter tile module 328. The administration module 330, in the depicted embodiment, includes an organization module 332, a user module 334, a notification module 336, and a workflow definition module 338.

In one embodiment, the project module 206 may engage the idea module 302 to keep a record of ideas for projects. In a certain embodiment, the idea module 302 may provide a user with an interface for entering an idea. In certain embodiments, the idea module may record additional information for an idea, such as the person who submitted the idea, the date of submission, or the like. For example, in a further embodiment, the idea module 302 may link an idea to metrics or objectives supported by the idea. As a further example, in one embodiment, the idea module 302 may present a list of first-level metrics, and prompt the user who enters the idea to select the metric or metrics that the idea supports.

In another embodiment, the idea module 302 may prompt the user who enters the idea to enter an estimated effort for the idea and an estimated impact for the idea. In a further embodiment, the idea module 302 may prompt the user who enters the idea to indicate whether the idea is for a corrective action. In a further embodiment, the idea module 302 may provide an interface for users to “like” ideas, and may track how many users like each idea, thus indicating the popularity or momentum of ideas, which may, in turn, indicate which ideas are good candidates for projects. Various additional types of information that may be associated with an idea, in further embodiments, are clear in light of this disclosure.

In one embodiment, the project module 206 may engage the idea filter module 304 to display a list of ideas from the record of ideas kept by the idea module 302, filtered according to one or more criteria selected by a user. In one embodiment, the idea filter module 304 may filter the list of ideas according to objectives or metrics supported by the idea. For example, in one embodiment, a user may select a single objective or metric, and the idea filter module 304 may present a list of ideas that support the selected objective or metric. In another embodiment, a user may select multiple objectives and/or metrics, and the idea filter module 304 may present a list of ideas that each support the full combination of selected objectives and/or metrics, or may present a list of ideas that support at least one of the selected objectives and/or metrics.

In a further embodiment, the idea filter module 304 may display a list of ideas filtered according to estimated effort and/or estimated impact, as received from the user by the idea module 302. For example, in one embodiment, the idea filter module 304 may present an effort/impact matrix indicating how many ideas the idea module 302 has received for each combination of effort and impact levels, and a user may select one or more cells of the effort/impact matrix to see a list of ideas filtered by the idea filter module 304 according to the selected effort and impact levels.

In various embodiments, the idea filter module 304 may display a list of ideas filtered in various ways, including lists of ideas filtered according to whether an idea is for a corrective action, filtered according to a range of submission dates (e.g., most recent ideas), filtered according to a union or intersection of other filters, or the like. In light of this embodiment, many ways of filtering ideas are clear.

In one embodiment, the project module 206 may create a new project based on an idea. For example, in a further embodiment, a user may select an idea from the list of ideas displayed by the idea filter module 204, and the project module 206 may create a new project based on the idea, and associate the new project with the idea. In certain embodiments, associating a new project with the record for an idea allows attributes of the idea such as effort, impact, whether the idea/project is a corrective action, or the like, to carry over to the project.

In one embodiment, the project module 206 may engage the project filter module 306 similarly to the idea filter module 304, to display a list of projects according to one or more criteria selected by a user. In a further embodiment, the project filter module 306 may display aggregate information pertaining to the listed projects. For example, in one embodiment, the project filter module 306 may display a list of projects filtered according to project completion status, type of project workflow, department responsible for the project, or the like, or according to a combination of filters, In a further embodiment, the project filter module 306 may display aggregate information for the projects in the filtered list, such as total savings due to completed project, by month, number of projects completed per month, project completion status for all corrective actions on the filtered list, or the like. In light of this disclosure, many types of aggregate information are clear that may be displayed for a filtered list of projects.

In certain embodiments, the idea filter module 304 and/or the project filter module 306 may display a filter interface for a user that includes a standard or default set of filters that may be applied. In further embodiment, the idea filter module 304 and/or the project filter module 306 may provide options for a user to modify a filter interface by adding or removing filters.

In one embodiment, the project module 206 may engage the workflow module 308 to display a workflow for a project. In certain embodiments, a workflow may include a list of tasks associated with a project. In further embodiments, a project may be completed when the workflow or list of tasks is completed. In one embodiment, the workflow module 308 may prompt a user who creates a project to select a predefined workflow for the project, and may automatically populate a list of tasks for the project according to the predefined workflow. As used herein, a “predefined” workflow refers to a workflow that is defined at any time before the workflow module 308 uses it to automatically populate a list of tasks. In one embodiment, a predefined workflow may be a default workflow included with the business tracking apparatus 104. In another embodiment, a predefined workflow may be a customized, reusable workflow defined by a user as described below with regard to the workflow definition module 338.

In various embodiments, certain predefined workflows provide predictable benefits. For example, Six Sigma (or similar) projects may use a Define, Measure, Analyze, Improve, and Control (“DMAIC”) workflow that provides a predictable path for improving business processes, that includes required tasks related to defining a business problem, measuring current baselines, analyzing root causes of a problem, deploying improvements, and controlling or maintaining a solution. Thus, in one embodiment, the workflow module 308 may automatically populate a list of tasks according to a predefined DMAIC workflow.

In another embodiment, the workflow module 308 may automatically populate a list of tasks according to a predefined Plan-Do-Check-Act (“PDCA”) workflow. In light of this disclosure, many predefined workflows are clear that may be suitable for the workflow module 308 to use, in various embodiments, to automatically populate a list of tasks. In a further embodiment, the workflow module 308 may provide an interface for a user to manually enter a list of tasks for a project, or to edit the list of tasks for the project.

In one embodiment, the workflow module 308 may customize a workflow to include a list of tasks in groups with sub-tasks. In one embodiment, the workflow module 308 may display all tasks in a list together in chronological order. In another embodiment, however, the workflow module 308 may display tasks sorted into their various task groups.

In one embodiment, the workflow module 308 may provide an interface for people associated with a task to record information pertaining to the task. In various embodiments, information pertaining to the tasks may include various types of information, such as a message to other people associated with the task, an indication whether the task is completed, a document attached to the task, a training video or other interactive media to be viewed by users working on the task, or the like. In light of this disclosure, various methods for tracking and managing workflows are clear. For example, techniques in use by existing project management software may also be used by the workflow module 308, in certain embodiments.

In one embodiment, the user dashboard module 310 may display information about a user in association with one or more objectives, metrics, and/or projects associated with the user. For example, in certain embodiments, the objective module 202, the metric module 204, and the project module 206 may link individual users to objectives, metrics, and projects, or may link organizations and members of organizations to the objectives, metrics, and projects. In further embodiments, a user may be associated with an objective, a metric, or a project as a team member, as a contributor, or by various other association types.

In various embodiments, the user dashboard module 310 may display varying amounts of information about a user in association with related objectives, metrics, and/or projects. For example, in one embodiment, the user dashboard module may 310 display the user's name, but in another embodiment, the user dashboard module 310 may display the user's name, position, hire date, and/the like. In various embodiments, the user dashboard module 310 may display a list of objectives, metrics, and/or projects directly supported by the user, a tree of objectives, metrics, and/or projects supported by the first objectives, metrics, and/or projects, or the like. By displaying objectives, metrics, and/or projects associated with or supported by a user, the user dashboard module 310, in some embodiments, may allow a user to easily see and understand his or her effect on a business or other organization.

In one embodiment, the tile module 320 may display data. In certain embodiments, the objective module 202, the metric module 204, the project module 206, or related modules of the business tracker apparatus 104 may use the tile module 320 to display data. In another embodiment, however, the tile module 320 may display data as part of a different apparatus, which may or may not be related to tracking business strategy and performance.

In one embodiment, the tile module 320 may display a plurality of tiles. In various embodiments, a tile may be a unit for data display, and the tile module 320 may display multiple, regularly arranged tiles, such as an array or grid of rectangular or square tiles. By presenting an array of tiles with a regular amount of data per tile, the tile module 320, in some embodiments, allows users to easily visualize and understand data. For example, in one embodiment, the objective module 202 may display an objective, and may use the tile module 320 to display a tile with information about each supporting factor for the objective.

Similarly, in another embodiment the metric module 204 may use the tile module 320 to display a dashboard that displays metrics and supporting factors in tile form. In a further embodiment, the project module 306 may use the tile module 320 to display multiple projects in tile form, to display aggregate information in tile form for a list of projects, to display filter controls for a list of ideas or projects, or to display multiple pieces of information about a single project in tile form. In light of this disclosure, many applications of tiles for displaying data are clear.

In one embodiment, selecting a tile may open a detailed view that displays more information that the tile module 320 may display on a single tile. In another embodiment, the tile module 320 may allow users to rearrange tile by clicking and dragging one or more tiles to new locations or positions. For example, in one embodiment, a user may click and drag one tile from the middle of an array of tiles to the end, and the tile module 320 may display the tiles in the array in a rearranged order, accordingly.

In one embodiment, the tile module 320 may display an array or grid of tiles together as a dashboard. In a certain embodiment, the tile module 320 may define multiple dashboards, and provide a scrolling display between dashboards, or a continuous scrolling display along a single dashboard. In a further embodiment, the tile module 320 may allow a user to pause a scrolling dashboard display to view particular tiles. In one embodiment, the tile module 320 may provide an interface for a user to customize a dashboard or dashboard to define what data will be displayed by individual tiles.

In a certain embodiment, a tile may include a chart or graph, and the tile module 320 may engage the chart module 322 to display a chart for the tile. In a further embodiment, the chart module 322 may display a pie chart, bar chart, line chart, doughnut chart, histogram, timeline, or the like for a tile. In light of this disclosure, many types of chart are clear which may be suitable for displaying data on a tile. In another embodiment, however, the tile module 320 may display a tile without using the chart module 322 to display a chart. For example, in one embodiment, a user may select a condensed view, and the tile module 320 may display smaller, condensed tiles, without charts.

In one embodiment, the tile module 320 may engage the data connection module 324 to connect a chart created by the chart module 322 to data for the chart. In a certain embodiment, the data connection module 324 may connect data to a chart by receiving data manually entered by a user, linking the chart to a data source or spreadsheet, linking the chart to one attribute of items in a list that may be filtered by selecting a region of the chart, or the like. In a further embodiment, the data connection module 324 may connect the chart to a data source in response to a user activating a data connection control for the tile that includes the chart. For example, in one embodiment, a user may activate a data connection control by clicking a region of the tile that activates the tile module 320 to display a reverse side of the tile.

As used herein, a reverse side of the tile may refer to a display that replaces the normal display for the tile, as if it were the reverse side of a physical tile. However, the tile may not be literally reversed. Yet, in some embodiments, the tile module 320 may indicate the relation between a tile and its reverse side by displaying an animation of a tile turning over when the reverse side is selected. In some embodiments, the data connection module 324 may connect a chart to a data source by presenting a form on the reverse side of the tile for receiving the data.

In one embodiment, the tile module 320 may engage the color scheme module 326 to display a color scheme for a tile according to a category for the tile. In various embodiments, a color scheme may refer to any particular application of a color, or a combination of colors, that visually distinguishes tiles for one category from tiles from another category. For example, in certain embodiments, the color scheme module 326 may define color schemes that include different colors for tile backgrounds, tile borders, default chart colors, or the like.

In further embodiments, various categories for tiles may correspond to various types of data displayed, or may correspond to various tile features such as the ability to use the tile to filter a list. For example, in one embodiment, the business tracking apparatus 104 may display complex interconnections between tiles displayed by the tile module 320 to represent various objectives, metrics, and/or projects, and the color scheme module 326 may display one color scheme for tiles representing objectives, another tile scheme for tiles representing metrics, and a third color scheme for tiles representing projects.

In one embodiment, the tile module 320 may engage the filter tile module 328 to display a list associated with the tile, filtered according to a portion of the chart selected by a user. For example, in one embodiment, the project filter module 306 may use the tile module 320 in connection with the filter tile module 328 to display a list of projects, and to display a filter tile that includes a pie chart with different segments for completed, active, or on hold projects. In a further embodiment, a user may select the “active” segment of the pie chart, and the filter tile module 328 may filter the list to include only active projects. In some embodiments, the filter tile module 320 may display a single list with multiple filter tiles for filtering the list according to multiple criteria.

In certain embodiments, the administration module 330 may manage administrative functions for the business tracking apparatus 104. For example, in one embodiment, the administration module 330 may engage the organization module 332 to define an organizational structure for a business or other organization. In a further embodiment, the organization module 332 may associate various organizational units with objectives, metrics, and/or projects. In general, associating an organizational unit (such as a department, branch, region, or the like) with an objective, a metric, or a project, may indicate that the organizational unit supports or is otherwise responsible for or connected with that objective, metric, or project.

In a further embodiment, the organization module 332 may display the organizational structure in association with objectives, metrics, and/or projects associated with a unit of the organization. For example, in one embodiment, the organization module 332 may display an organizational structure as a tree, or an indented list representing a tree, and may show a list of objectives, metrics, or projects associated with each unit of the organization. In another embodiment, the organization module 332 may display a simplified tree that displays a number of objectives, metrics, and/or projects associated with each organizational unit, and a user may expand branches of the tree to see objectives, metrics, and/or projects associated with a particular organizational unit. In view of this disclosure, many ways of displaying objectives, metrics, and projects in association with units of an organizational structure are clear.

In one embodiment, the administration module 330 may engage the user module 334 to create and manage user records. For example, in one embodiment, the user module 334 may receive information about a user, such as a name, an employee hire data, a position, and the like. In a further embodiment, the user module 334 may interact with the organization module 332 to record which organizations a user belongs to. Various further techniques for managing and tracking user records using a user module 334 are clear in light of this disclosure.

In one embodiment, the administration module 330 may engage the notification module 336 to send notifications to users. In various embodiments, a notification may include any information sent to a user, whether displayed by the business tracking apparatus 104 itself via the browser 110, or whether sent to the user via email, text message, or the like. In one embodiment, the notification module 336 may allow a user to compose and immediately send a notification to other users.

In another embodiment, the notification module 336 may allow a user to schedule a notification for a specific time, or to set up a notification that will be sent in response to a particular event occurring. Events that may trigger notifications may, in various embodiments, be associated with a particular objective, metric or project, or with a group of objectives, metrics, or projects. For example, in one embodiment, the notification module 336 may allow a user to set up a notification that it automatically sends out to users associated with any task, shortly before the task is due. In another embodiment, the notification module 336 may send a notification to a manager when a particular project is completed. In another embodiment, the notification module 336. Various types of notification and events that may trigger a notification are clear in light of this disclosure.

In one embodiment, the administration module 330 may engage the workflow definition module 338 to provide an interface for the user to create or edit predefined workflows used by the workflow module 308. For example, in a certain embodiment, the workflow definition module may create a named workflow, and allow a user to define a list of tasks for the workflow. In a further embodiment the workflow module 308 may then use one of the predefined workflows from the workflow definition module 338 to automatically populate a list of tasks for a project.

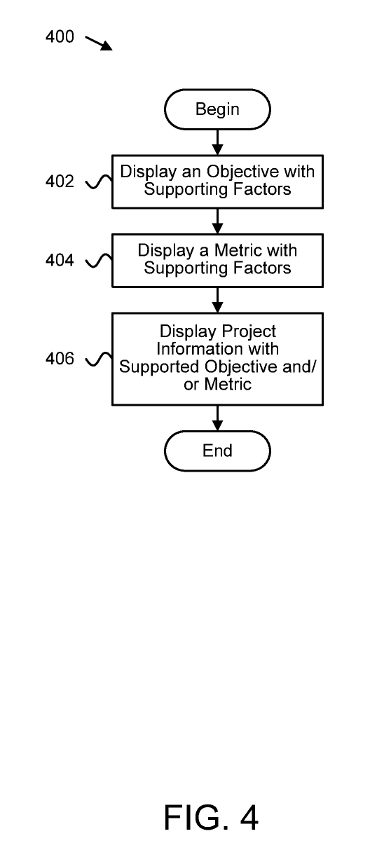

FIG. 4 depicts one embodiment of a method 400 for tracking business strategy and performance. The method 400 begins, and the objective module 202 displays 402 an objective with supporting factors for the objective. The metric module 204 displays 404 a metric with supporting factors for the metric. The project module 206 displays 406 information about a project with at least one objective or metric supported by the project, and the method 400 ends

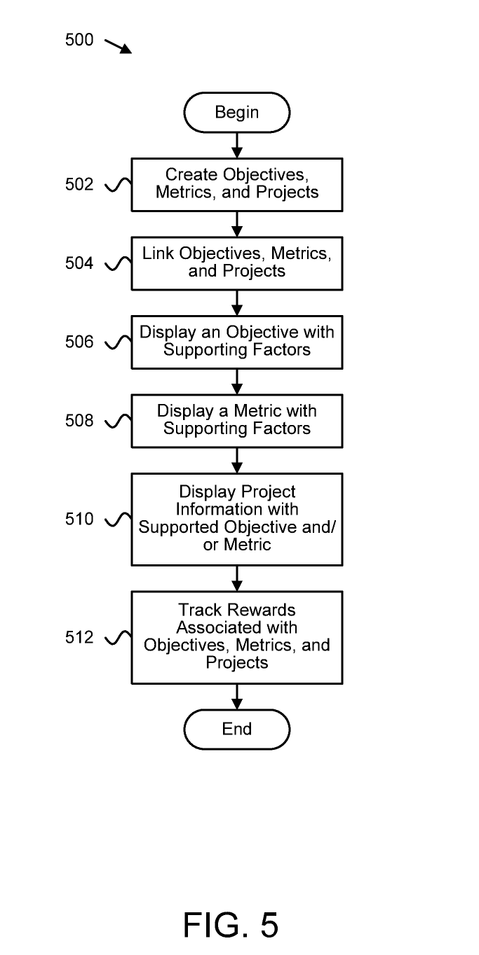

FIG. 5 depicts another embodiment of a method 500 for tracking business strategy and performance. The method 500 begins, and the objective module 202, the metric module 204, and the project module 206 create 502 objectives, metrics, and projects. The objective module 202, the metric module 204, and the project module 206 link 504 objectives, metrics, and projects as described above with regard to FIG. 2. The objective module 202 displays 506 an objective with supporting factors for the objective. The metric module 204 displays 508 a metric with supporting factors for the metric. The project module 206 displays 510 information about a project with at least one objective or metric supported by the project. The reward module 208 tracks 512 rewards associated with objectives, methods, and projects, and the method 500 ends.

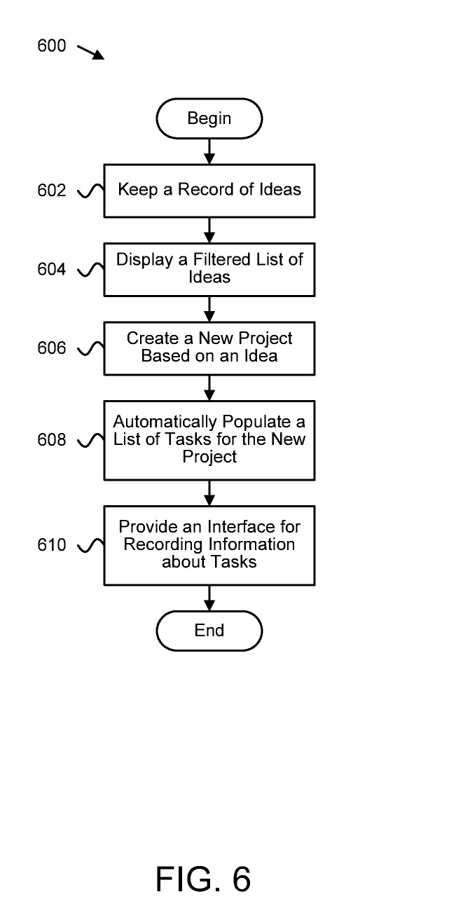

FIG. 6 depicts another embodiment of a method 600 for tracking business strategy and performance. The method 600 begins and the idea module 302 keeps 602 a record of ideas. The idea filter module 304 displays 604 a filtered list of ideas, and the project module 206 creates 606 a new project based on an idea. The workflow module 308 automatically populates 608 a list of tasks for the new project. The workflow module 308 additionally provides 610 an interface for recording information about the tasks for the new project, and the method 600 ends.

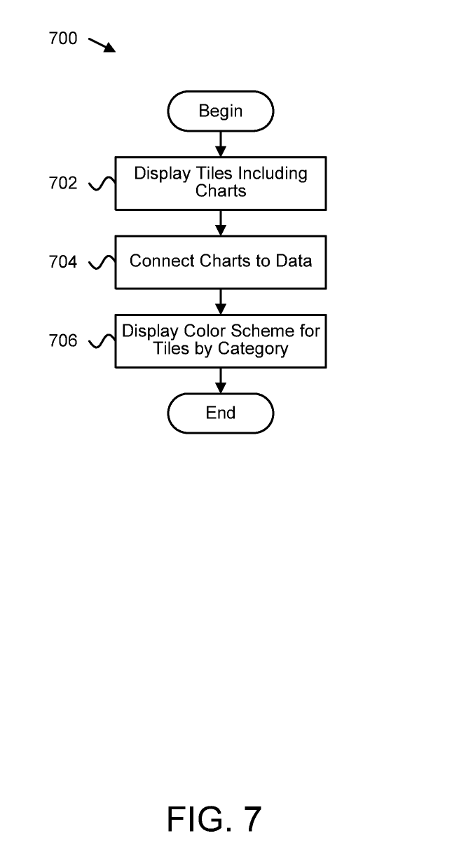

FIG. 7 depicts one embodiment of a method 700 of data display. The method 700 begins, and the tile module 320 engages the chart module 322 to display 702 tiles including charts. The data connection module 324 connects 704 charts to data. The color scheme module 326 displays 706 a color scheme for tiles according to tile categories, and the method 700 ends

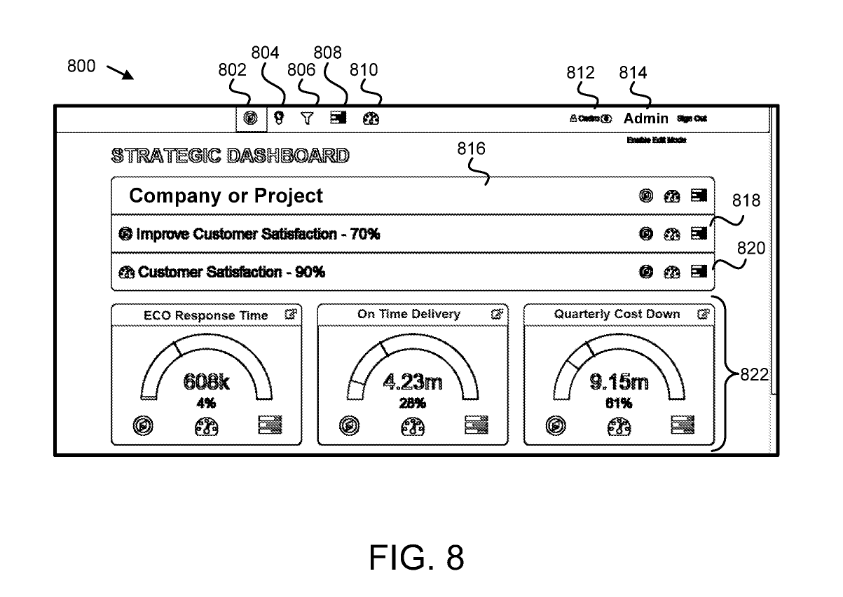

FIG. 8 depicts one embodiment of a web page 800 presented by the business tracking apparatus 104. The schematic block diagrams of FIGS. 8-17 have certain aspects in common, which may be referenced in the first Figure in which they appear, but which may not be referenced in subsequent figures, to avoid repetition. The schematic block diagrams of FIGS. 8-17 depict various embodiments of the business tracking apparatus 104, and are intended as illustrative and not limiting; in another embodiment, a business tracking apparatus 104 might present information in a different way.

In the depicted embodiment, the web page 800 include a control bar in the upper portion of the web page 800, and various portions of the control bar act as links to activate various modules of the business tracking apparatus. For example, the compass symbol 802 is a link to a web page presented by the objective module 202. The light bulb symbol 804 is a link to a web page presented by the idea module 302. The funnel symbol 806 is a link to a web page presented by the idea filter module 304. The list symbol 808 is a link to a web page presented by the project filter module 306. The speedometer symbol 810 is a link to a web page presented by the metric module 204. The user's name 812 is a link to a web page presented by the user dashboard module 310, and the admin link 814 on the right side is a link to a web page presented by the administration module 330.

In the depicted embodiment, the web page 800 is a strategic dashboard displayed by the objective module 202, which displays an objective, or a tree of objectives, along with supporting factors. The web page 800 includes three items 816, 818, and 820 in a list representing a tree, and a dashboard that uses the tile module 320 to display three tiles which represent supporting factors for the last item in the tree 820. The first item 816 in the list is a placeholder objective which acts as the root of a tree of objectives, as described above.

The second item 818, “Improve Customer Satisfaction—70%,” is a first-level objective (as indicated by the compass icon) which is linked to the placeholder objective 816 as a supporting factor. The third item 820, “Customer Satisfaction—90%” is a metric (as indicated by the speedometer icon) which is linked to the customer satisfaction objective 818 as a supporting factor. In list form, the current value of the metric is displayed along with the name of the metric instead of as a separate chart. The tiles 822 are additional metrics that are linked to the customer satisfaction metric 90% as a supporting factor. A blue background or another colored background of the tiles 820 may be a color scheme indicating that the tiles represent metrics. The compass, speedometer, and list links at the right of each list item and at the bottom of each tile allow a user to create or view supporting factors for an item, including additional objectives, metrics, and projects, respectively and are highlighted if an item already has supporting factors.

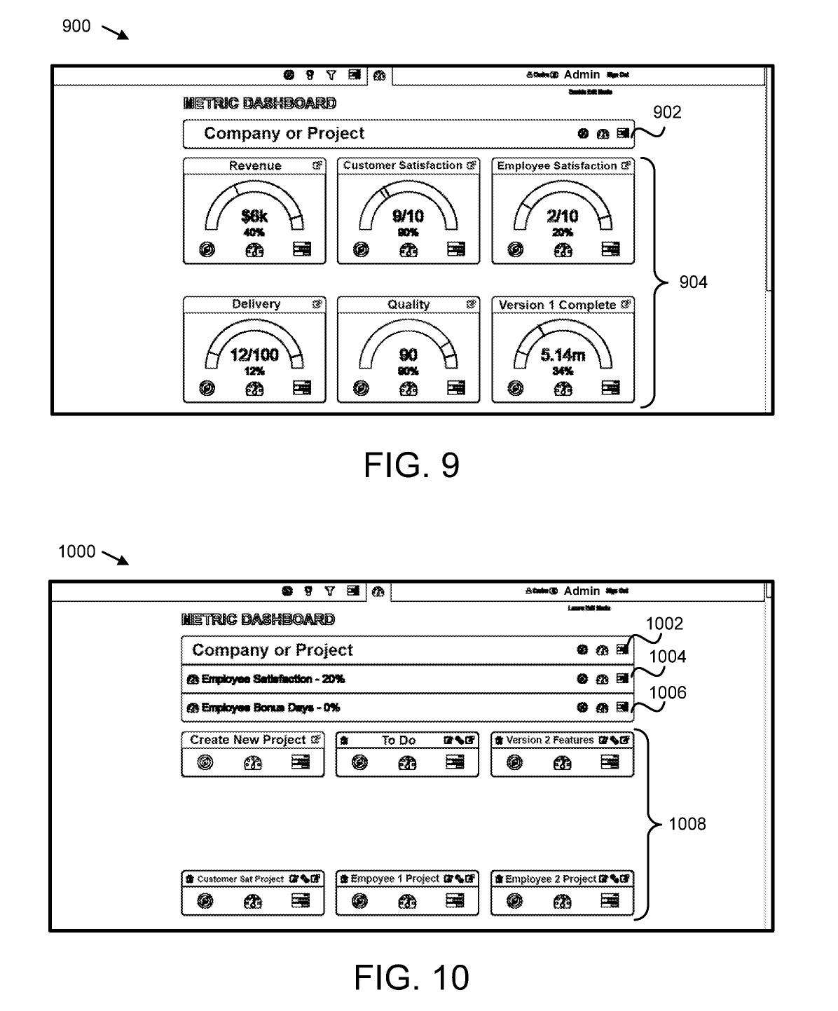

FIG. 9 depicts another embodiment of a web page 900 presented by the business tracking apparatus 104. In the depicted embodiment, the web page 900 is a metric dashboard displayed by the metric module 204. In the depicted embodiment, a single metric 902 is used as a placeholder, so that a single dashboard 904 may be created with supporting metrics. The dashboard 904 includes tiles representing six metrics, as described above with regard to FIG. 8.

FIG. 10 depicts another embodiment of a web page 1000 presented by the business tracking apparatus 104. In the depicted embodiment, the web page 1000 is a metric dashboard displayed by the metric module 204, similar to the web page 900 of FIG. 9. In the depicted embodiment the placeholder metric 1002 has supporting metrics, as indicated by the highlighted speedometer icon. Employee Satisfaction 1004 is a first supporting metric, and Employee Bonus Days 1006 is a second supporting metric, which has supporting projects, as indicated by the highlighted list icon. The tiles 1008 underneath Employee Bonus Days 1006 represent supporting projects, and are displayed by the tile module 320 in a condensed view, without charts. A yellow color scheme or another color scheme of the tiles 1008 may indicate that they correspond to projects.

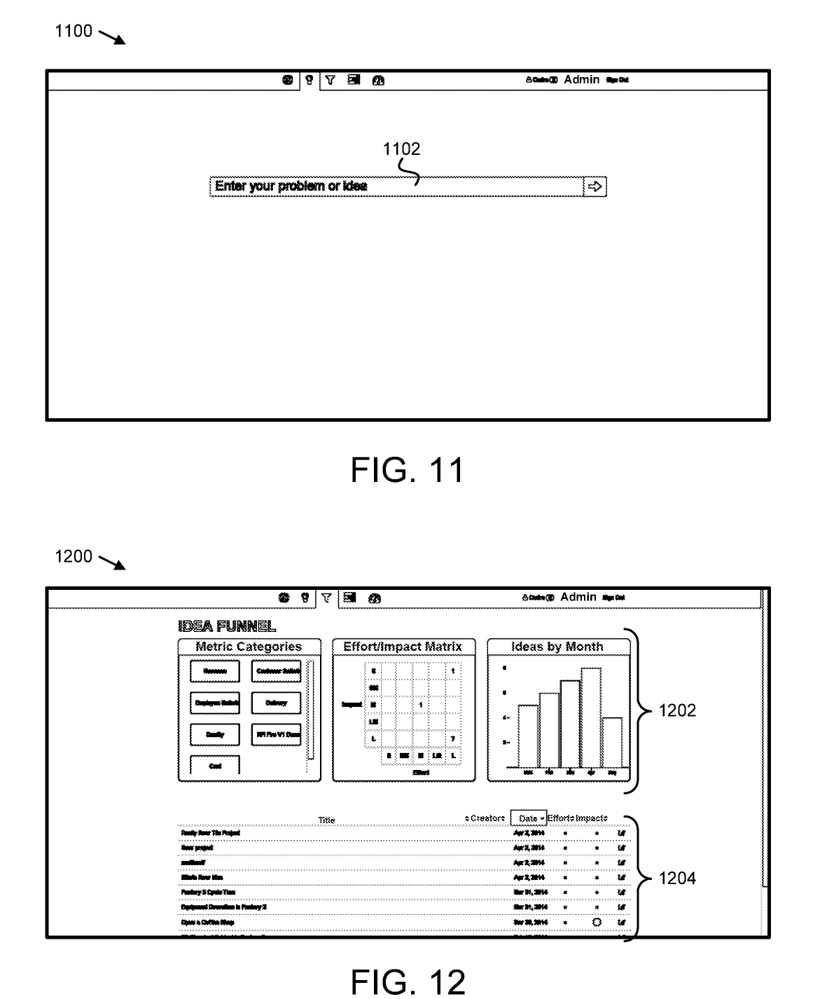

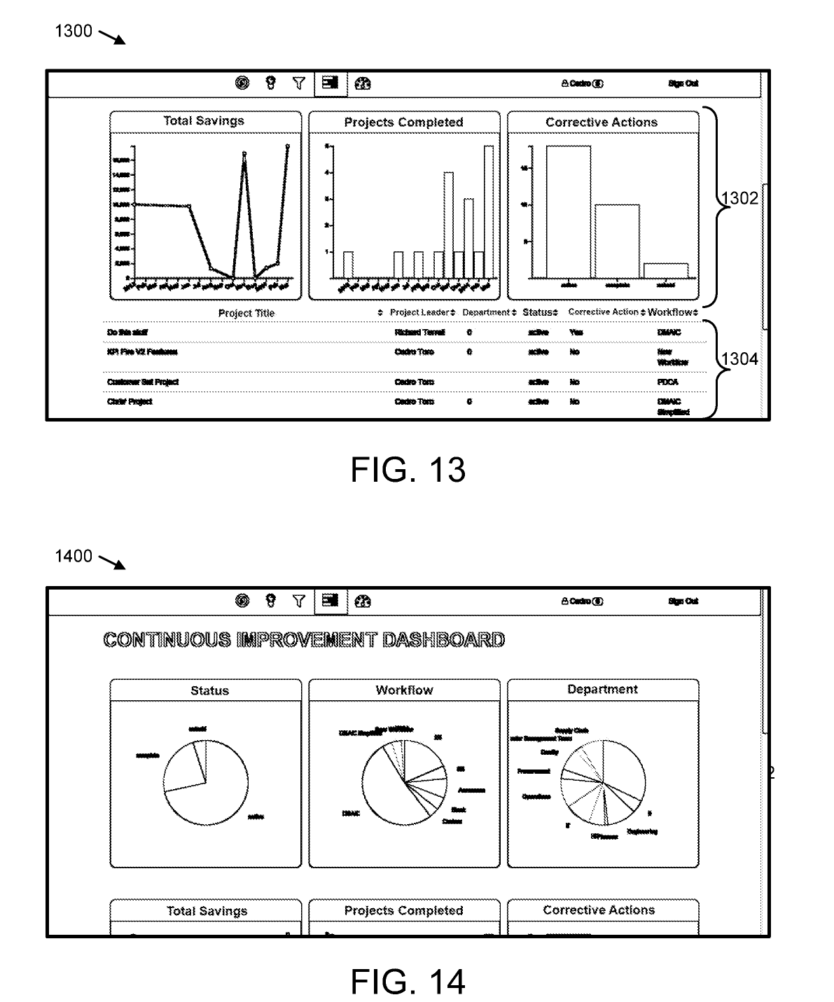

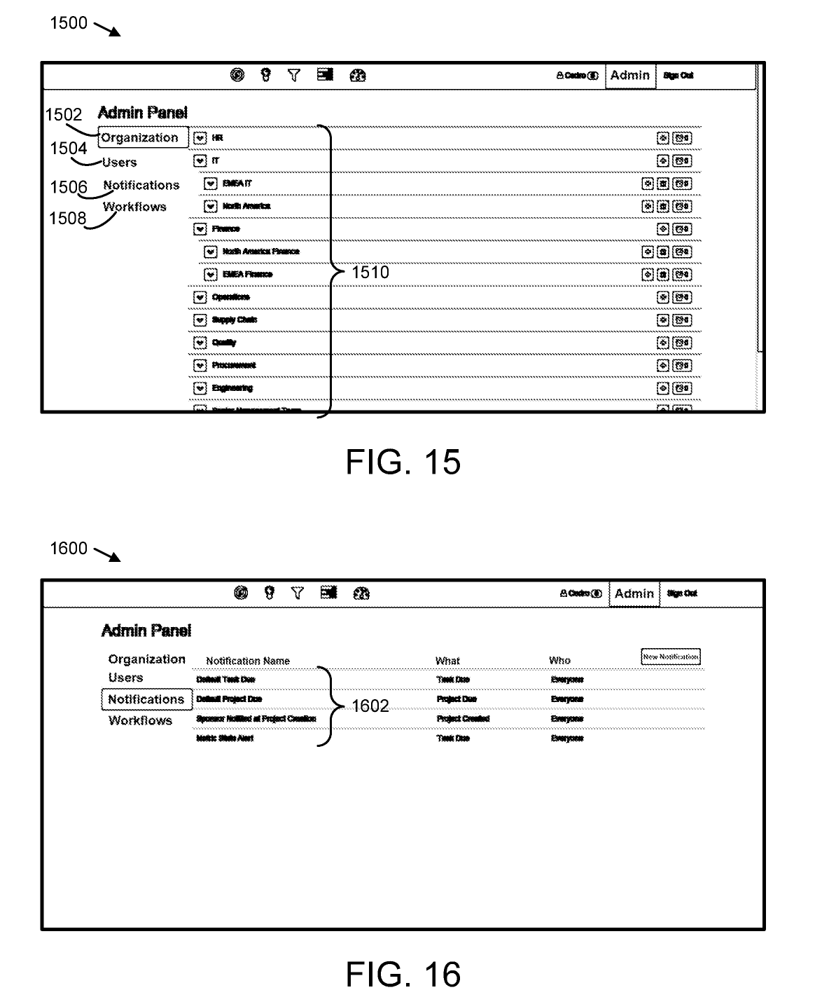

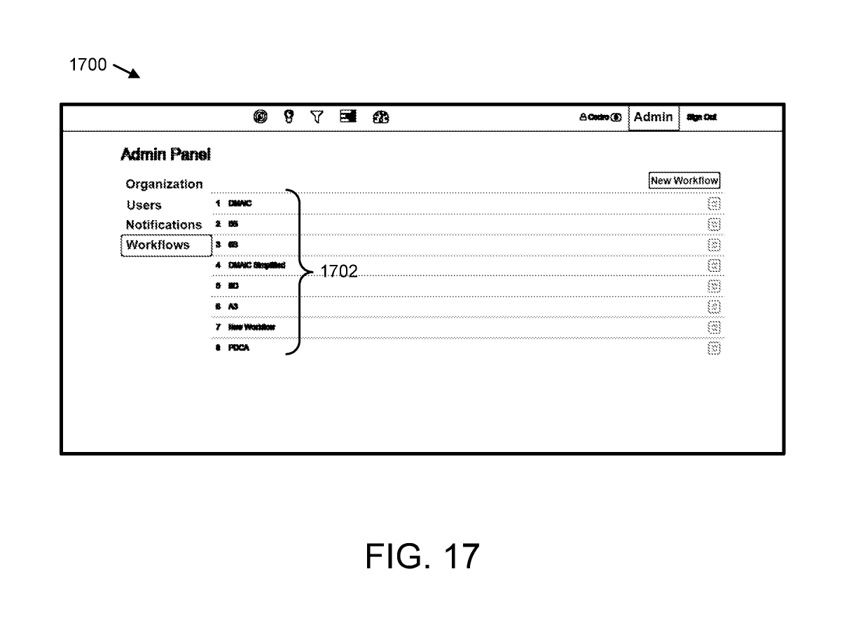

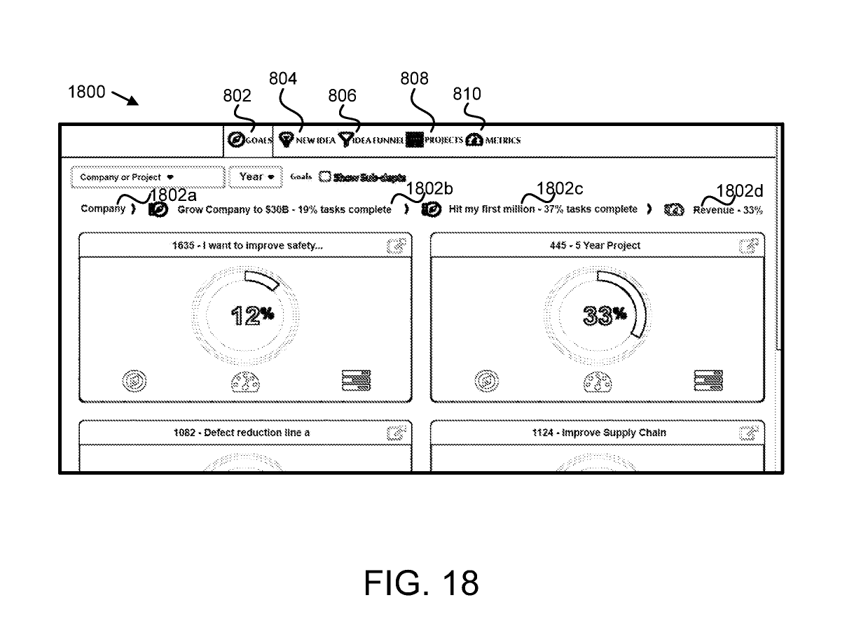

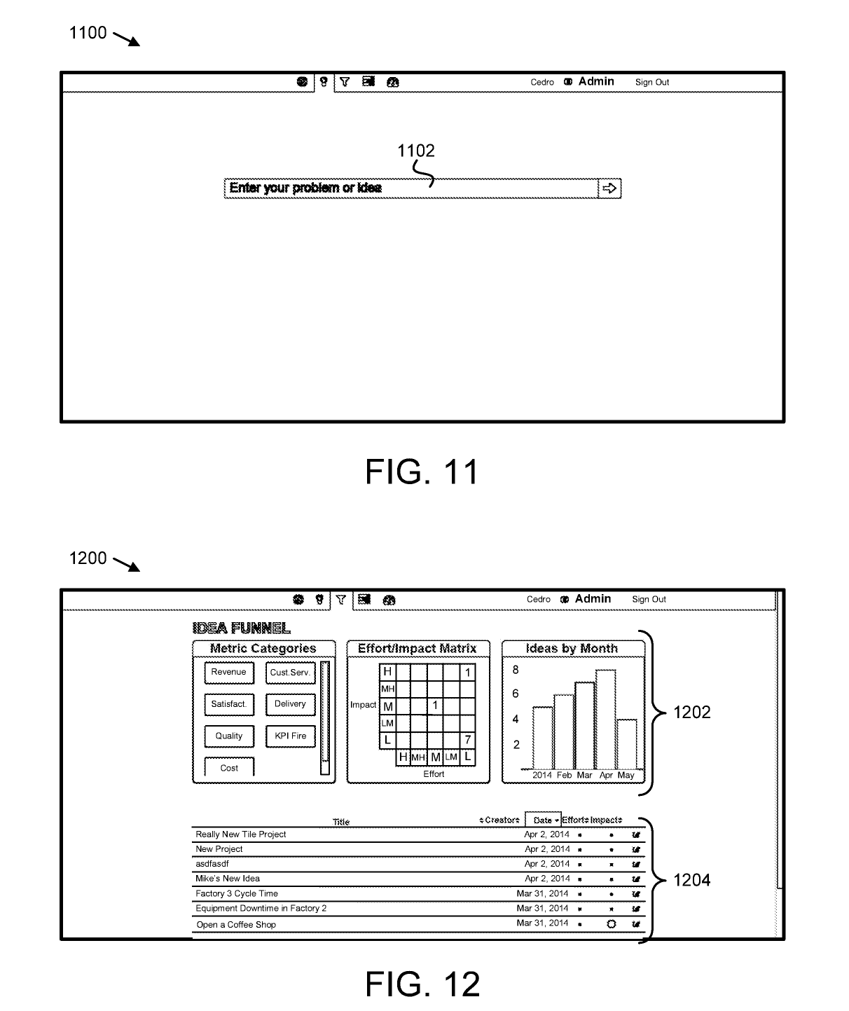

FIG. 11 depicts another embodiment of a web page 1100 presented by the business tracking apparatus 104. In the depicted embodiment, the web page 1100 is displayed by the idea module 302, and presents a single-filed form 1102 for a user to enter an idea (or a problem) that may lead to a project.

FIG. 12 depicts another embodiment of a web page 1200 presented by the business tracking apparatus 104. In the depicted embodiment, the web page 1200 is presented by the idea filter module 304, and includes filter tiles 1202 that allow a user to filter a list 1204 of ideas. For example, the filter tile 1202 on the left allows a user to filter the list 1204 of ideas according to a first-level metric. The middle filter tile 1202 allows a user to filter the list 1204 by selecting a cell or cells of an effort/impact matrix. The filter tile 1202 on the right allows a user to filter the list 1204 of ideas by month.

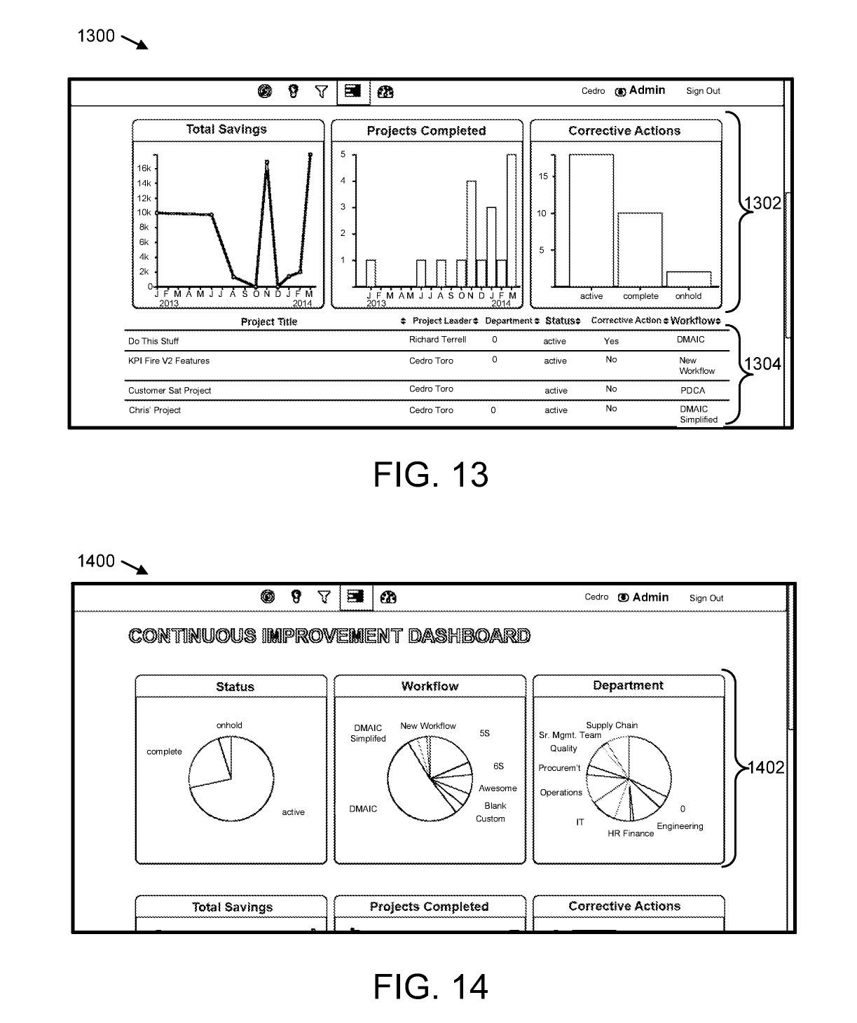

FIG. 13 depicts another embodiment of a web page 1300 presented by the business tracking apparatus 104. In the depicted embodiment, the web page 1300 is presented by the project filter module 306, and displays a list of projects 1304 with tiles 1302 representing aggregate information about projects in the list 1304, such as total savings by month, projects completed by month, and number of corrective actions active, completed, or on hold.

FIG. 14 depicts another embodiment of a web page 1400 presented by the business tracking apparatus 104. In the depicted embodiment, the web page 1400 is presented by the project filter module, and is the upper part of the web page 1300 depicted in FIG. 13. The web page 1400 includes filter tiles 1402, which the project filter module uses to filter the list of projects. For example, a user may select the “active” segment of the “status” pie chart in the first filter tile 1402 to view a list of active projects.

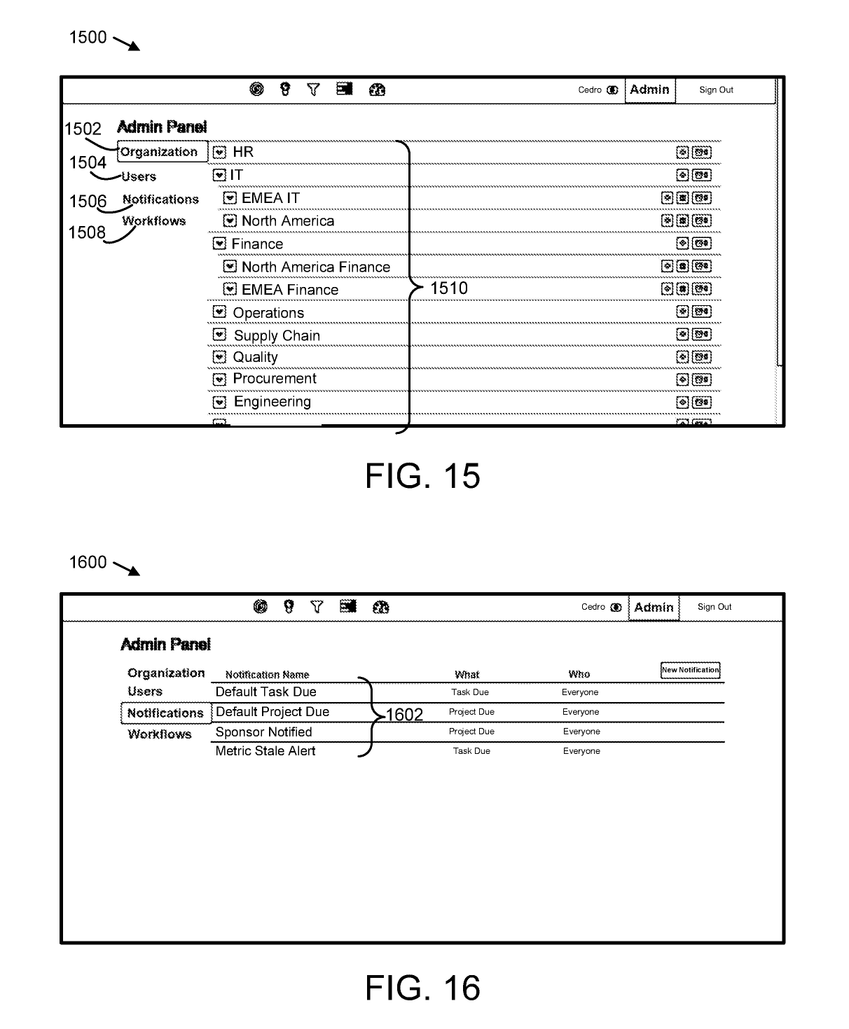

FIG. 15 depicts another embodiment of a web page 1500 presented by the business tracking apparatus 104. In FIGS. 15-17, the depicted web pages are presented by the administration module 330. The “organization” link 1502 is a link to a web page presented by the organization module 332. The “users” link 1504 is a link to a web page presented by the user module 334. The “notifications” link 1504 is a link to a web page presented by the notification module 336. The “workflow” link 1504 is a link to a web page presented by the workflow definition module 338. In the depicted web page 1500, the “organization” link 1502 is highlighted, and the web page 1500 displays an organization structure 1510 in the form of an indented list representing a tree. Controls on the right side for each unit on the organization structure 1510 allow a user to create or delete subunits in the organization, or to view objectives, metrics, and projects associated with the organizational units.

FIG. 16 depicts another embodiment of a web page 1600 presented by the business tracking apparatus 104. In the depicted embodiment, the web page 1600 is presented by the notification module and includes a list 1602 of notifications that have been set up, including what events trigger the notifications, and who the notifications are sent to.

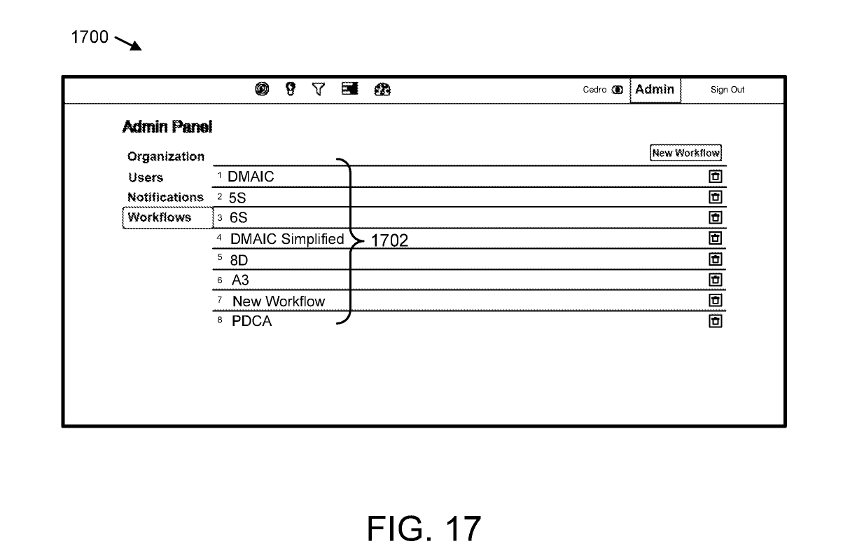

FIG. 17 depicts another embodiment of a web page 1700 presented by the business tracking apparatus 104. In the depicted embodiment, the web page 1700 is presented by the workflow definition module 338, and includes a list 1702 of predefined workflows that the workflow module 308 may use to automatically populate task lists for projects. By clicking on different workflows in the list 1702, or other links, a user may create, modify, or delete the various workflows.

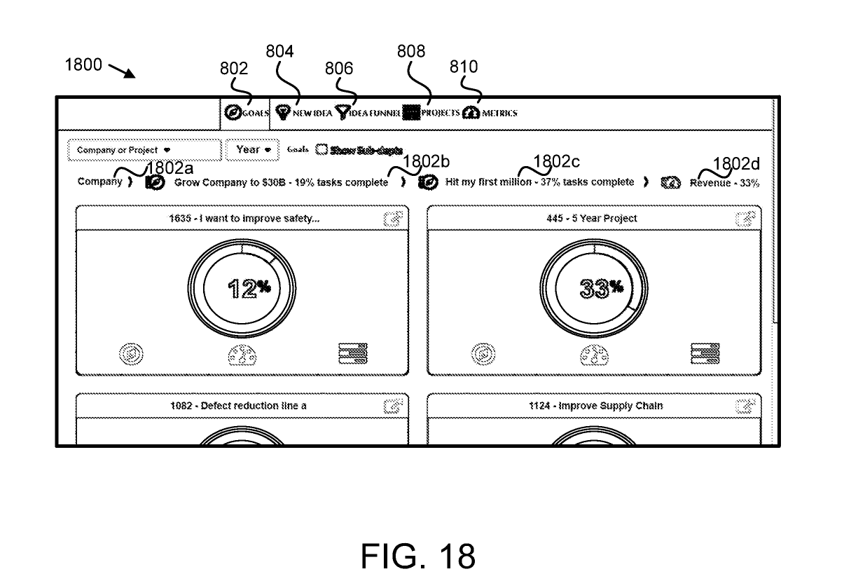

FIG. 18 depicts another embodiment of a web page 1800 presented by the business tracking apparatus 104. In the embodiment depicted in FIG. 18, the objective module 202 displays one or more objectives, or a tree of objectives, along with supporting factors. The objective module 202, the metric module 204, and/or the project module 206, in the depicted embodiment, display one or more elements 1802a-d comprising a smart breadcrumb 1802, with one or more embedded and/or dynamically updated objectives, supporting factors for one or more objectives, metrics, supporting factors for one or more metrics, or the like. The smart breadcrumb 1802 comprises an ordered list of one or more projects, goals, objectives, metrics, supporting factors, or other dynamic and/or static elements. A smart breadcrumb 1802 may be based on an ordered hierarchy of pages or views provided by the business tracking apparatus 104 (e.g., displayed in a hierarchical order); a history of pages or views provided by the business tracking apparatus 104 (e.g., in a historical order in which a user visited the pages or views); a hierarchy of goals, objectives, metrics, and/or supporting factors; or the like.

In the depicted embodiment, the smart breadcrumb 1802 comprises a first element 1802a (e.g., head, home, parent, and/or a placeholder objective which acts as the root of a tree of objectives, as described above), such as a company or project selected by a user, followed by one or more additional elements 1802b-d (e.g., child elements 1802b-d). As described above, the object module 202 may display one or more icons, such as a compass icon, to indicate that an element 1802a-d comprises an objective; the metric module 204 may display one or more icons, such as a speedometer icon, to indicate that an element 1802a-d comprises a metric; or the like.

One or more elements 1802a-d of a smart bread crumb may comprise a dynamic and/or custom metric and/or supporting factor, associated with an objective, with another metric, or the like. For example, in the depicted embodiment, the second element 1802b of the smart bread crumb comprises a metric (e.g., a supporting factor) indicating “19% tasks complete” for an objective to “grow company to $30B”, the third element 1802c of the smart bread crumb comprises a metric (e.g., a supporting factor) indicating “37% tasks complete” for an objective to “hit my first million”, and the fourth element 1802d of the smart bread crumb comprises a metric (e.g., a supporting factor) of “33%” for a metric of “revenue”. In this manner, in certain embodiments, the objective module 202 and/or the metric module 204 may provide a user with additional information, such as metrics or other supporting factors, without requiring the user to navigate to a different page or view, and/or may dynamically update the provided information at or near real time as the provided information changes.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an objective module that displays an objective in association with one or more supporting factors for the objective, at least one of the supporting factors for the objective comprising one or more of another objective, a metric, and a project;
a metric module that displays a metric in association with one or more supporting factors for the metric, at least one of the supporting factors for the metric comprising one or more of an objective, another metric, and a project; and
a project module that displays information associated with a project in association with one or more of an objective and a metric supported by the project.

2. The apparatus of claim 1, further comprising a reward module that keeps a record of an association between an action, a reward for the action, and one or more of an objective, a metric, a project, a group of objectives, a group of metrics, and a group of projects supported by the action.

3. The apparatus of claim 2, wherein the reward module rewards a person according to the associated reward for performing the action.

4. The apparatus of claim 3, wherein the reward comprises a virtual reward, and the reward module rewards the person by adding the virtual reward to a cumulative reward total for the person.

5. The apparatus of claim 1, wherein the project module keeps a record of ideas for projects and displays a list of ideas from the record of ideas filtered according to one or more selected criteria.

6. The apparatus of claim 5, wherein the project module filters the list of ideas according to one or more of an objective and a metric supported by the idea.

7. The apparatus of claim 5, wherein the project module filters the list of ideas according to effort and impact for the ideas.

8. The apparatus of claim 5, wherein the project module associates a new project with an idea from the list of ideas.

9. The apparatus of claim 1, wherein the project module indicates whether the displayed project is a corrective action.

10. The apparatus of claim 1, further comprising a workflow module that displays a workflow for the displayed project, the workflow comprising a list of tasks, the workflow module automatically populating the list of tasks in response to a user selecting a predefined workflow.

11. The apparatus of claim 10, wherein the workflow module provides an interface for one or more users associated with a task to record information pertaining to the task.

12. The apparatus of claim 1, further comprising a project filter module that displays a list of projects filtered according to one or more selected criteria, and that displays aggregate information pertaining to the listed projects.

13. The apparatus of claim 1, further comprising a user dashboard module that displays information associated with a user in association with one or more of an objective, a metric, and a project associated with the user.

14. The apparatus of claim 1, further comprising an organization module that displays information associated with an organizational structure in association with one or more of an objective, a metric, and a project associated with a unit of the organization.

15. The apparatus of claim 1, wherein one or more of the displayed objective, the displayed metric, and the displayed information is displayed as an element of a smart breadcrumb comprising an ordered list of multiple elements.

16. An apparatus comprising:
a tile module that displays a plurality of tiles, wherein a tile comprises a chart;
a data connection module that connects the chart to data for the chart in response to a user activating a data connection control for the tile; and
a color scheme module that displays a color scheme for the tile according to a category for the tile.

17. The apparatus of claim 16, wherein activating the data connection control for the tile comprises activating a display of a reverse side for the tile, and the data connection module connects the chart to the data by presenting a form on the reverse side of the tile for receiving the data.

18. The apparatus of claim 16, further comprising a filter tile module that displays a list associated with the tile, filtered according to a portion of the chart selected by the user.

19. The apparatus of claim 16, wherein the tile module displays the plurality of tiles in a rearranged order in response to the user clicking and dragging the tile to a new position.

20. A method comprising:
displaying an objective in association with one or more supporting factors for the objective, at least one of the supporting factors for the objective comprising one or more of another objective, a metric, and a project;
displaying a metric in association with one or more supporting factors for the metric, at least one of the supporting factors for the metric comprising one or more of an objective, another metric, and a project;
displaying information associated with a project in association with one or more of an objective and a metric supported by the project, wherein one or more of the displayed objective, the displayed metric, and the displayed information is displayed as an element of a smart breadcrumb comprising an ordered list of multiple elements; and
storing a record of an association between an action, a reward for the action, and one or more of an objective, a metric, a project, a group of objectives, a group of metrics, and a group of projects supported by the action.
